(19) United States
(12) Patent Application Publication
(10) Pub. No.: US 2026/0008699 A1
(43) Pub. Date: Jan. 8, 2026

(54) METHOD AND SYSTEM FOR REMOVING AZOLE-BASED COMPOUNDS FROM A WASTEWATER

(71) Applicant: BL Technologies, Inc., Minnetonka, MN (US)

(72) Inventors: Raed LABBAN, Glen Allen, VA (US); Nabin CHOWDHURY, Glen Allen, VA (US); Denise HORNER, Ormond Beach, FL (US)

(21) Appl. No.: 18/992,173

(22) PCT Filed: Jul. 14, 2023
(86) PCT No.: PCT/US2023/070245

§ 371 Date: Jan. 7, 2025

Related U.S. Application Data
(60) Provisional application No. 63/391,914, filed on Jul. 25, 2022.

(51) Int. Cl. C02F 1/00; C02F 1/52; C02F 1/56; C02F 1/66; C02F 1/68; C02F 101/20; C02F 101/38; C02F 103/34

(52) U.S. Cl. CPC C02F 1/001; C02F 1/5245; C02F 1/5281; C02F 1/56; C02F 1/66; C02F 1/683; C02F 2101/20; C02F 2101/38; C02F 2103/346; C02F 2209/001; C02F 2209/003; C02F 2209/06; C02F 2209/16

(57) ABSTRACT

The present disclosure provides a method for reducing or removing azole-based compounds from a wastewater, such as a semiconductor wastewater. The method includes adding a solution comprising transition metal (II) ions to a wastewater that includes an azole compound; and allowing the transition metal (II) ions and the azole compound in the wastewater to form a transition metal-azole complex in the wastewater. The transition metal ions may be Cu²⁺ ions and/or Zn²⁺ ions.

### RELATED APPLICATIONS

This application claims priority to, and the benefit of, U.S. Provisional Patent Application No. 63/391,914, filed Jul. 25, 2022, which is incorporated herein by reference.

### FIELD

This specification relates to a method and system for reducing or removing azole-based compounds from a wastewater.

### BACKGROUND

The following paragraphs are not an admission that anything discussed in them is prior art or part of the knowledge of persons skilled in the art.

Azoles are a class of five-membered heterocyclic chemical compounds with a nitrogen atom and at least one other heteroatom as part of the ring. Some azole compounds are used in the fabrication process of semiconductor devices as anticorrosive compounds for copper. Wastewater produced from such fabrication processes can be treated using an oxidizing agent, such as ozone, hydrogen peroxide, or irradiation with ultraviolet light, to reduce or remove the azole compounds.

U.S. Pat. No. 8,801,937 discloses a process for removing an azole-type anticorrosive compound for copper from semiconductor wastewater. The process reacts a ferrous ion with the azole-type compounds at a pH from 4 to 8 to form an insoluble iron-azole complex, which is removed by flocculation/solid-liquid separation. The solid-liquid separated water is subsequently oxidized in an ozone-based process to obtain a treated water having a triazole concentration, in terms of TOC, of 1.5 mg/L or less.

The '937 patent shows that water containing 1,2,4-triazole at a concentration of 300 mg/L as TOC can be treated with ferrous sulfate at 2000 mg/L, and subsequently with a polymer flocculant to produce a treated water with a TOC concentration of 54 mg/L.

The '937 patent also shows that water containing 1,2,4-triazole at a concentration of 180 mg/L can be treated with ferrous sulfate at 5000 mg/L, and subsequently with a polymer flocculant to produce a filtered water with a triazole concentration of 90 mg/L. Oxidizing that filtered water using an ozone-based process resulted in a treated water having a triazole concentration of less than 1.5 mg/L.

### INTRODUCTION

The following introduction is intended to introduce the reader to this specification but not to define any invention. One or more inventions may reside in a combination or sub-combination of the apparatus elements or method steps described below or in other parts of this document. The inventors do not waive or disclaim their rights to any invention or inventions disclosed in this specification merely by not describing such other invention or inventions in the claims.

The effluent discharged by a wastewater treatment plant may be regulated with limits for parameters such as total nitrogen (TN). Total nitrogen may be reduced by treating an influent wastewater to a process that includes nitrification. Nitrification is a biological process that converts ammonia to nitrite, and nitrite to nitrate. Azole compounds can inhibit the biological transformation of ammonia to nitrate. In some situations, even a wastewater containing 1 mg/L of 1,2,4-triazole may be sufficiently detrimental to a nitrification treatment process that the wastewater produced by the nitrification process is unable to meet the local discharge limits. In some situations, it may be desirable to reduce the concentration of a soluble azole compound to less than 1 mg/L, such as less than 0.5 mg/L or less than 0.1 mg/L, in the wastewater being treated to nitrification. Although an azole-containing wastewater produced by an industrial process, such as by semiconductor fabrication, may be diluted with an azole-free wastewater before the nitrification process to provide the desired concentration, it may alternatively or additionally be desirable to reduce the concentration of the soluble azole compound in the wastewater produced by an industrial process.

In some aspects of the present disclosure, the methods and systems may treat the wastewater without using an oxidation step or oxidizing unit to reduce or remove the soluble azole compound. In other aspects of the present disclosure, the methods and systems may treat the wastewater using an oxidation step or oxidizing unit to reduce or remove the soluble azole compound.

In one aspect, the present disclosure provides a method for reducing or removing azole-based compounds from a wastewater, such as a semiconductor wastewater. The method includes adding a solution comprising transition metal (II) ions to a wastewater that includes an azole compound; and allowing the transition metal (II) ions and the azole compound in the wastewater to form a transition metal-azole complex in the wastewater. The transition metal ions may be Cu²⁺ ions, Zn²⁺ ions, and/or Mn²⁺ ions.

The transition metal-azole complex may be soluble or insoluble under specific wastewater conditions. For example, the transition metal-azole complex may be soluble at one pH and insoluble at a different pH. Insoluble transition metal-azole complex may be removed, such as through coagulation, flocculation, and/or a solid-liquid separation process, and the azole-reduced wastewater may be further treated in a biological treatment that includes nitrification. Alternatively, the wastewater containing the transition metal-azole complex may be transferred to a biological treatment reactor that performs nitrification so long as the reactor conditions render the transition metal-azole complex insoluble.

In another aspect, the present disclosure provides a wastewater treatment system that includes: a source of wastewater that includes an azole compound; a reactor in fluid communication with the source of the wastewater; a source of a solution comprising transition metal (II) ions in fluid communication with the reactor; and a solids-liquid separator in fluid communication with the reactor. The solution comprising transition metal (II) ions may include Cu²⁺ ions, Zn²⁺ ions, and/or Mn²⁺ ions.

The system may also include a biological treatment unit in fluid communication with a liquid outlet from the reactor or the solids-liquid separator. The biological treatment unit treats the accepted wastewater to nitrification. The system may include a source of a pH-modifying solution, such as a base, in fluid communication with the reactor, the biological treatment unit, or a fluid stream between the reactor and the biological treatment unit.

In one particular example according to the present disclosure, the method includes adding a solution that includes Cu²⁺, Zn²⁺, and/or Mn²⁺ ions to a semiconductor wastewater that includes an azole compound; maintaining the wastewater at a pH between 4 and 9; allowing the copper, zinc, and/or manganese ions and the azole compound in the wastewater to form a copper-azole, zinc-azole, and/or manganese-azole complex in the wastewater; removing at least some of the copper-azole, zinc-azole, and/or manganese-azole complex from the wastewater to produce an azole-reduced wastewater; and treating the azole-reduced wastewater to a biological treatment process that includes nitrification.

In another particular example according to the present disclosure, the method includes adding a solution that includes Cu²⁺, Zn²⁺ and/or Mn²⁺ ions to a semiconductor wastewater that includes an azole compound; allowing the copper, zinc, and/or manganese ions and the azole compound in the wastewater to form a copper-azole, zinc-azole, and/or manganese-azole complex in the wastewater; treating the wastewater to a biological treatment process that includes nitrification, where the biological treatment process is maintained at a pH between 4 and 9.

In another aspect, the present disclosure provides a method that includes: adding a solution comprising Cu²⁺ ions to a semiconductor wastewater that includes a triazole compound, such as 1,2,4-triazole; and allowing the copper ions and the triazole compound in the wastewater to form a copper-triazole complex in the wastewater while maintaining the solution at a pH greater than 4 to produce a treated wastewater. The method may optionally include removing at least some of the insoluble copper-triazole complex to produce a triazole-reduce wastewater; and optionally discharging the treated wastewater or the triazole-reduce wastewater to a downstream biological treatment that includes nitrification.

In yet another aspect, the present disclosure provides a wastewater treatment system that includes: a reactor that includes at least one liquid inlet and at least one liquid outlet; a source of semiconductor wastewater that includes a triazole compound, such as 1,2,4-triazole, in fluid communication with the reactor; a source of a solution comprising Cu²⁺ ions in fluid communication with the reactor; and a source of a pH-modifying solution, such as a base, in fluid communication with the reactor. The source of the pH-modifying solution is for maintaining the pH of the wastewater greater than 4. The system may optionally include a solids-liquid separator in fluid communication with the liquid outlet of the reactor.

In particular examples according to any of the methods and systems disclosed herein, the azole-containing wastewater may be a semiconductor wastewater and the solution that includes transition metal (II) ions may be or may include a semiconductor wastewater that includes Cu²⁺ ions. A method according to the present disclosure may include combining a sufficient amount of the copper ion-containing wastewater to react with substantially all of the azole compound in the other semiconductor wastewater.

In another aspect, the present disclosure provides a method of estimating or quantifying the concentration of azoles that are present in a solution. The method includes: providing a sample of the solution, titrating the solution with a Cu²⁺ solution as the titrant, performing a colorimetric analysis of the sample to determine when the titration endpoint has been reached, and determining the concentration of azoles based on the titrated volume of the titrant, the concentration of the titrant, and the volume of the sample. The Cu²⁺ solution may be a CuSO₄ or CuCl₂ solution.

### BRIEF DESCRIPTION OF THE DRAWINGS

Embodiments of the present disclosure will now be described, by way of example only, with reference to the attached FIGURES.

FIG. 1 is a process diagram of an exemplary wastewater treatment system according to the present disclosure.

### DETAILED DESCRIPTION

Generally, the present disclosure provides a method for reducing or removing an azole-based compound from a wastewater. The method includes adding a solution comprising transition metal (II) ions to a wastewater that includes an azole compound; and allowing the transition metal (II) ions and the azole compound in the wastewater to form a transition metal-azole complex in the wastewater. Methods according to the present disclosure may exclude oxidation of the azole compound, such as by treatment with ozone and/or hydrogen peroxide, as part of the process for reducing or removing azole-based compound from the wastewater. For example, methods according to the present disclosure may lack an oxidation treatment step upstream of a nitrification treatment.

A transition metal should be understood to refer to any element in the d-block of the periodic table that is in groups 3 to 12 of the periodic table. A transition metal (II) ion should be understood to refer to any transition metal ion in a +2 oxidation state.

The transition metal (II) ions may include Cu²⁺ ions, Zn²⁺ ions, Fe²⁺ ions, Cr²⁺ ions, Co²⁺ ions, Mn²⁺ ions, Ni²⁺ ions, or any combination thereof. In particular examples, the transition metal (II) ions include Cu²⁺, Zn²⁺, and/or Mn²⁺ ions. The copper ions may be provided in a copper sulfate or copper chloride solution. The copper ions may be provided in a copper ion-containing semiconductor wastewater. The copper ion-containing semiconductor wastewater may be, for example, a copper sulfate solution produced from the sulfuric acid-based regeneration of an ion-exchange resin that was used to remove copper ions from a solution. The method may include adding a sufficient amount of the solution to provide from 1 to 5 times, such as from 1 to 3 times, the stoichiometric ratio of transition metal (II) ions, such as copper ions, to azole compound.

The azole compound may be imidazole, pyrazole, oxazole, isoxazole, thiazole, isothiazole, selenazole, 1,2,3-triazole, 1,2,4-triazole, 1,2,5-oxadiazole, 1,3,4-oxadiazole, 1,2,3-thiadiazole, 1,2,4-thiadiazole, 1,3,4-thiadiazole, tetrazole, 1,2,3,4-thiatriazole, a derivative thereof, an amine salt thereof, or a metal salt thereof.

Examples of azole derivatives include compounds having a fused ring of an azole ring and a benzene ring or the like, such as indazole, benzimidazole, benzotriazole, and benzothiazole, and further include derivatives thereof, such as alkylbenzotriazoles (e.g., benzotriazole, o-tolyltriazole, m-tolyltriazole, p-tolyltriazole, 5-ethylbenzotriazole, 5-n-propylbenzotriazole, 5-isobutylbenzotriazole, and 4-methylbenzotriazole), alkoxybenzotriazoles (e.g., 5-methoxybenzotriazole), alkylaminobenzotriazoles, alkylaminosulfonylbenzotriazoles, mercaptobenzotriazoles, hydroxybenzotriazoles, nitrobenzotriazoles (e.g., 4-nitrobenzotriazole), halobenzotriazoles (e.g., 5-chlorobenzotriazole), hydroxyalkylbenzotriazoles, hydrobenzotriazoles, aminobenzotriazoles, (substituted aminomethyl)-tolyltriazole, carboxybenzotriazole, N-alkylbenzotriazoles, bisbenzotriazole, naphthotriazole, mercaptobenzothiazoles, aminobenzothiazole, amine salts thereof, and metal salts thereof.

In some examples, the azole compound includes a N—H functional group.

In particular examples, the azole compound may be a triazole compound or a pyrazole compound, such as: 1,2,4-triazole; 3-amino-1,2,4-triazole; 5-methyl-benzotriazole;

benzotriazole; pyrazole; or any combination thereof.

The wastewater may be a semiconductor wastewater, such as a semiconductor wastewater having a total azole concentration of up to 450 mg/L. The semiconductor wastewater may include: 1,2,4-triazole, such as at a concentration of up to 200 mg/L, for example a concentration from 5 to 20 mg/L; benzotriazole, such as a concentration of up to 80 mg/L, for example a concentration from 10 to 30 mg/L; 5-methyl benzotriazole, such as at a concentration of up to 80 mg/L, for example a concentration from 5 to 20 mg/L; pyrazole, such as at a concentration of up to 80 mg/L, for example a concentration of 0.1 mg/L or less; or any combination thereof.

Without wishing to be bound by theory, the authors of the present disclosure believe that copper(II) ions preferentially reduce or remove azole-based compounds that have three nitrogen atoms in the aromatic ring, such as triazole compounds, over azole-based compounds that have two nitrogen atoms in the aromatic ring, such as pyrazole. The preferential order of reactivity is believed to be 1,2,4-triazole>pyrazole>imidazole.

The transition metal-azole complex may be insoluble in the wastewater. When the transition metal-azole complex is insoluble in the wastewater, the method may also include removing at least some of the insoluble transition metal-azole complex to produce an azole-reduce wastewater. Removing at least some of the insoluble transition metal-azole complex may be performed by: filtering the wastewater to remove at least some of the insoluble complex; or adding a coagulant, such as ferric sulphate, ferric chloride, or ferrous sulphate, and/or a flocculent, such as a polymeric flocculent, and optionally clarifying the flocculated and/or coagulated wastewater.

Before removing at least some of the insoluble transition metal-azole complex, the method may also include adding a sufficient amount of a pH-modifying agent, such as a base, to the wastewater to result in a pH greater than 4, such as about pH 6. For example, the transition metal-azole complex may be a Cu²⁺-1,2,4-triazole complex, which is soluble in water at a pH below 4, but insoluble at a pH above 4.

A wastewater containing 1,2,4-triazole and treated with copper sulfate may additionally be treated with a base, such as sodium hydroxide, to provide a wastewater at a pH greater than 4, such as about pH 6. Such a wastewater includes insoluble copper(II)-1,2,4-triazole complex, and the method may include removing at least some of that insoluble copper(II)-1,2,4-triazole complex by filtering the wastewater, by adding a flocculent, coagulant, or both and optionally clarifying the flocculated and/or coagulated wastewater, or a combination thereof.

Wastewater with a reduced amount of azole compound may be treated in a biological treatment that includes nitrification. As noted above, methods according to the present disclosure lack an oxidation treatment step upstream of the nitrification treatment.

When the transition metal-azole complex is insoluble under the biological treatment conditions, a method according to the present disclosure may include treating the wastewater in a biological treatment that includes nitrification without first removing at least some of the insoluble transition metal-azole complex to produce an azole-reduce wastewater. For example, a wastewater containing 1,2,4-triazole and treated with copper sulfate may additionally be treated with a base, such as sodium hydroxide, to provide a wastewater at a pH greater than 4, such as about pH 6. The resulting copper(II)-1,2,4-triazole complex is insoluble at that pH, and the exemplary method includes treating the wastewater in a biological treatment that includes nitrification. The insoluble copper(II)-1,2,4-triazole complex may be removed from the wastewater in a treatment process downstream from the biological treatment process. In some examples, the wastewater treated with copper(II) ions is not treated to oxidation before the nitrification treatment.

In another aspect, the present disclosure provides a wastewater treatment system that includes: a source of wastewater that includes an azole compound; a reactor in fluid communication with the source of the wastewater; and a source of a solution that includes transition metal (II) ions in fluid communication with the reactor. The system may also include a solids-liquid separator in fluid communication with the reactor.

The solution that includes transition metal (II) ions may include Cu²⁺ ions, Zn²⁺ ions, Fe²⁺ ions, Cr²⁺ ions, Co²⁺ ions, Mn²⁺ ions, Ni²⁺ ions, or any combination thereof. In particular examples, the solution includes Cu²⁺, Zn²⁺, and/or Mn²⁺ ions. The solution may be a copper sulfate or a copper chloride solution. The solution may be or may include a copper ion-containing semiconductor wastewater, such as a copper sulfate solution produced by regenerating an ion-exchange resin that was used to remove copper ions from a solution.

The wastewater treatment system may also include a source of a pH-modifying solution, such as a base, in fluid communication with the reactor. The system may include a pH-monitor and a controller to maintain the pH of the wastewater greater than 4, such as at about pH 6. Alternatively, the system may add the pH-modifying solution based on the molar amount of the azole compounds known to be in the influent wastewater solution.

The solids-liquid separator may include: a filter, such as a filter having a pore size of 0.1 microns or less, for example a filter having a membrane with an average pore size of about 0.025 μm, or a source of a flocculent and/or coagulant, and optionally a clarifier.

The wastewater treatment system may also include a biological treatment unit in fluid communication with a liquid outlet from the reactor or the solids-liquid separator. The biological treatment unit may accept an azole-reduced wastewater from the solids-liquid separator, or may accept a wastewater having insoluble transition metal-azole complex. The biological treatment unit treats the accepted wastewater to nitrification. The nitrification may be performed in a membrane aerated bioreactor. The system may lack an oxidation unit, such as a treatment unit that includes an ozone injector, that removes azole compounds upstream of the biological treatment unit.

The wastewater treatment system may accept wastewater from a semiconductor fabrication plant. The wastewater treatment system may accept a copper-ion containing wastewater from a semiconductor fabrication plant.

In another aspect, the present disclosure provides a method that includes: providing a sample of the solution, titrating the solution with a Cu²⁺ solution as the titrant, and performing a colorimetric analysis of the sample to determine when the titration endpoint has been reached. The Cu²⁺ solution may be a CuSO₄ or CuCl₂ solution.

The method may be used to estimate or quantify the concentration of azoles that are present in a solution, in which case the method includes determining the concentration of azoles based on the titrated volume of the titrant, the concentration of the titrant, and the volume of the sample.

The sample may be a sample of wastewater, such as semiconductor wastewater, for example semiconductor fabrication wastewater. Examples of semiconductor wastewater are discussed above. Estimating the concentration of azoles that are present in the solution may be used to determine how many moles of transition metal (II) ions should be added in a wastewater treatment method, such as one discussed above, in order to produce an azole-reduced wastewater.

When the sample is a sample of semiconductor wastewater, the Cu²⁺ solution used as a titrant may be a copper ion-containing semiconductor wastewater. The volumetric ratio of (titrant needed to reach the titration endpoint:sample) provides a volumetric ratio of (copper ion-containing semiconductor wastewater:semiconductor wastewater) that may be used to produce an azole-reduced wastewater in a wastewater treatment method as disclosed above.

In some examples, at least 60 mol %, such as at least 70 mol %, at least 80 mol %, or at least 90 mol %, of the azoles in the sample are azole-based compounds that have three nitrogen atoms in the aromatic ring, such as triazole compounds. In some examples, less than 10 mol %, such as less than 5 mol % or less than 1 mol %, of the azoles in the sample are azole-based compounds that have two nitrogen atoms in the aromatic ring, such as pyrazole compounds.

The colorimetric analysis of the sample undergoing titration may be performed by using a direct or indirect method of detecting copper to determine when the titration endpoint has been reached. A direct detection method may include visual detection of copper sulfate, or colorimetric detection at a wavelength from 750 to 900 nm. An indirect detection method may include a bicinchoninate or bathocuproine method to quantify dissolved copper(II) in the titration sample. An indirect detection method may be performed using an EZ1000 Series Online Colorimetric Copper Analyzer, such as an EZ1010 or EZ1011 analyzer, from Hach Company.

In other aspects, the titration may be performed using a Zn²⁺ or Mn²⁺ solution instead of the Cu²⁺ solution discussed above. Analysis of the titration sample to detect Zn²⁺ or Mn²⁺ to determine when the titration endpoint has been reached may include an indirect detection method. An indirect detection method of Zn²⁺ may be performed using an EZ1040 Zn(II) Analyzer from Hach Company, which uses 2-carboxy-2′hydroxy-5′sulfoformazyl benzene indicator, commonly called zincon, in the ZincoVer® Method for determining zinc concentration. An indirect detection method of Mn²⁺ may be performed using an EZ1025 Mn(II) Analyzer from Hach Company, which uses a formaldoxime method for determining manganese concentration.

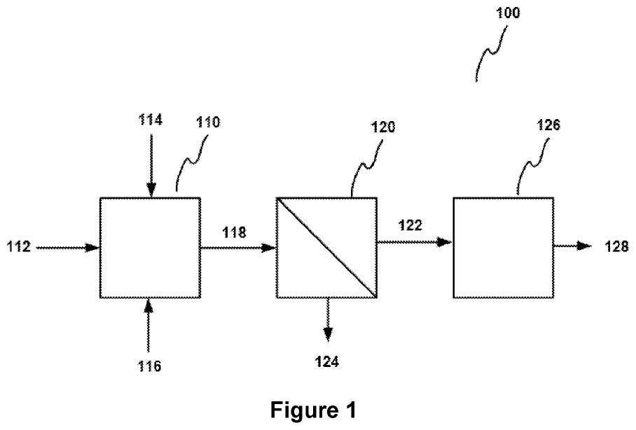

An exemplary wastewater treatment system is illustrated in FIG. 1. The system (100) includes a reactor (110) with an inlet for accepting a wastewater (112), such an a semiconductor wastewater. The wastewater (112) includes an azole compound. The reactor (110) also includes an inlet for accepting a solution (114) that includes transition metal (II) ions. The solution (114) may be a copper-containing semiconductor wastewater that includes Cu²⁺ ions. The reactor (110) includes an inlet for accepting a pH-modifying solution (116).

The reactor (110) outputs a process stream (118) with a transition metal-azole complex, which is accepted into a solids-liquid separator (120). The system may include a source of a flocculent and/or coagulant (not shown). The solids-liquid separator (120) produces an azole-reduced wastewater (122) and an azole-concentrated waste product (124).

The azole-reduced wastewater (122) is accepted into a biological treatment unit (126) that treats the accepted wastewater to nitrification. The biological treatment unit (126) outputs a nitrogen-reduced wastewater (128).

Example 1. Deionized water was spiked with 1,2,4 triazole, pyrazole, benzotriazole, and 5-methyl benzotriazole to produce a solution containing 180 mg/L of 1,2,4 triazole, 60 mg/L of pyrazole, 60 mg/L of benzotriazole and 60 mg/L of 5-methyl benzotriazole. The solution was treated with different concentrations of copper sulfate solution (103.7, 207.4, 414.7, 829.4, 1037.0 and 1244.4 mg/L), while maintaining the pH at 6.0. The resulting insoluble copper-azole complex was removed by filtering through a 0.025 μm membrane. The filtered solutions were tested for TOC as a surrogate for the amount of remaining azole compounds, and for residual copper. The results are shown in Table 1.

TABLE 1

| Copper sulfate | Residual DOC | Residual copper |
|---|---|---|
| treatment (mg/L) | (mg/L) | (mg/L) |
| 103.7 | 128.0 | <0.05 |
| 207.4 | 110 | <0.05 |
| 414.7 | 71.4 | <0.05 |
| 829.4 | 22.9 | 3.2 |
| 1037.0 | 16.2 | 15.6 |
| 1244.4 | 20.5 | 44.5 |

In addition, the filtered solution treated with 1037 mg/L of copper sulfate was tested for the specific azoles used in the synthetic wastewater. The compounds (in mg/L) contained in the effluents are: 0.22 mg/L of 1,2,4-triazole; 0.38 mg/L of benzotriazole; 22 mg/L of pyrazole; and 0.14 mg/L of 5-methyl benzotriazole.

Examples 2 and 3. In view of the positive results from the study outlined above, synthetic wastewater was prepared to mimic a semiconductor wastewater. The synthetic wastewater had the characteristics shown in Table 2:

TABLE 2

| Parameters | Unit | Amount |
|---|---|---|
| pH | s.u. | 3.2-7 |
| Alkalinity | mg/L as CaCO₃ | NA |
| UV Transmissivity | % | NA |
| Conductivity | mS/cm | NA |
| Total Dissolved Solids | mg/L | about 5,800 |
| Total Suspended Solids | mg/L | NA |
| TOC | mg/L | about 1,500 |
| tCOD | mg/L | about 2800 |
| sCOD | mg/L | about 2800 |
| BOD5 | mg/L | NA |
| NH4—N | mg-N/L | <800 |
| NO2—N | mg/L | NA |
| NO3—N | mg/L | NA |
| Total Nitrogen (NH₄OH) | mg-N/L | about 800 |
| TKN | mg-N/L | about 800 |
| TMAH | mg/L | NA |
| Total Azoles | mg/L | about 360 |
| 1,2,4 Triazole | mg/L | about 180 |
| Benzotriazole | mg/L | about 60 |
| Pyrazole | mg/L | about 60 |
| 5-Methylbenzotriazole | mg/L | about 60 |

Example 2. One particular synthetic wastewater had a pH of 6.5, a TDS of 5,650 mg/L, a total COD of 772 mg/L, a concentration of Ammonium-N of 767 mg-N/L, a concentration of 1,2,4 triazole of 177 mg/L, a concentration of benzotriazole of 60 mg/L, a concentration of 5-methyl benzotriazole of 64 mg/L, and a concentration of pyrazole of 62 mg/L.

This synthetic wastewater was treated with different concentrations of copper sulfate solution (414.7, 829.4, 1037.0 and 1244.4 mg/L), while maintaining the pH at 6.0. The resulting insoluble copper-azole complex was removed by filtering through a 0.025 μm membrane. The filtered solutions were tested for TOC as a surrogate for the amount of remaining azole compounds, and for residual copper. The results are shown in Table 3.

TABLE 3

| Copper sulfate | Residual DOC | Residual copper |
|---|---|---|
| treatment (mg/L) | (mg/L) | (mg/L) |
| 414.7 | 789 | <0.05 |
| 829.4 | 687 | 9.9 |
| 1037.0 | 685 | 25.4 |
| 1244.4 | 649 | 62.7 |

In addition, the filtered solutions were tested for the specific azoles used in the synthetic wastewater. The compounds (in mg/L) contained in the effluents are shown in Table 4:

TABLE 4

| Copper sulfate | 1,2,4 | | | 5-methyl |
|---|---|---|---|---|
| treatment (mg/L) | triazole | pyrazole | benzotriazole | benzotriazole |
| 414.7 | 51 | 56 | 58 | 52 |
| 829.4 | 0.037 | 39 | 5.0 | 2.1 |
| 1037.0 | 0.13 | 24 | 0.61 | 0.27 |
| 1244.4 | 0.29 | 28 | 0.86 | 0.35 |

Example 3. Another particular synthetic wastewater had a pH of 6.0, a concentration of 1,2,4 triazole of 140 mg/L, a concentration of benzotriazole of 54 mg/L, a concentration of 5-methyl benzotriazole of 58 mg/L, and a concentration of pyrazole of 53 mg/L.

This synthetic wastewater was treated with a copper sulfate solution at 1037.0 mg/L under reactions times between 5 and 20 minutes, while maintaining the pH at 6.0. The resulting insoluble copper-azole complex was removed by filtering through a 0.025 μm membrane. The filtered solutions were tested for TOC and residual copper and the results are shown in Table 5.

TABLE 5

| Reaction time | Residual DOC | Residual copper |
|---|---|---|
| (min) | (mg/L) | (mg/L) |
| 5 | 646 | 145 |
| 10 | 656 | 135 |
| 15 | 624 | 129 |
| 20 | 652 | 114 |

The filtered solutions were also tested for the specific azoles used in the synthetic wastewater. The compounds (in mg/L) contained in the effluents are shown in Table 6:

TABLE 6

| Reaction | 1,2,4 | | | 5-methyl |
|---|---|---|---|---|
| time (min) | triazole | pyrazole | benzotriazole | benzotriazole |
| 5 | 0.052 | 27.0 | 1.4 | 0.47 |
| 10 | 0.051 | 28.0 | 1.6 | 1.1 |
| 15 | 0.10 | 27.0 | 1.6 | 1.4 |
| 20 | 0.24 | 27.0 | 2.1 | 1.8 |

In the preceding description, for purposes of explanation, numerous details are set forth in order to provide a thorough understanding of the examples. However, it will be apparent to one skilled in the art that these specific details are not required. Accordingly, what has been described is merely illustrative of the application of the described examples and numerous modifications and variations are possible in light of the above teachings.

Since the above description provides examples, it will be appreciated that modifications and variations can be effected to the particular examples by those of skill in the art. Accordingly, the scope of the claims should not be limited by the particular examples set forth herein, but should be construed in a manner consistent with the specification as a whole.

1. A method comprising:
adding a solution comprising transition metal (II) ions to a wastewater that includes an azole compound; and
allowing the transition metal (II) ions and the azole compound in the wastewater to form a transition metal-azole complex in the wastewater.

2. The method according to claim 1, wherein the transition metal (II) ions comprise Cu²⁺ ions, Zn²⁺ ions, Fe²⁺ ions, Cr²⁺ ions, Co²⁺ ions, Mn²⁺ ions, Ni²⁺ ions, or any combination thereof.

3. The method according to claim 2, wherein the transition metal (II) ions are Cu²⁺ ions and the solution comprising Cu²⁺ ions is a copper sulfate or copper chloride solution, or comprises a copper ion-containing semiconductor wastewater.

4. The method according to claim 2, comprising adding a sufficient amount of the solution comprising Cu²⁺ ions to provide from 1 to 5 times, such as from 1 to 3 times, the stoichiometric ratio of copper ions to azole compound.

5. The method according to claim 1, wherein the azole compound is a triazole compound or a pyrazole compound, such as: 1,2,4-triazole; 3-amino-1,2,4-triazole; 5-methyl-benzotriazole; benzotriazole; pyrazole; or any combination thereof.

6. The method according to claim 5, wherein the wastewater is a semiconductor wastewater, such as a semiconductor wastewater having a total azole concentration of up to 450 mg/L, for example including: 1,2,4-triazole, such as at a concentration of up to 200 mg/L, for example a concentration from 5 to 20 mg/L; benzotriazole, such as a concentration of up to 80 mg/L, for example a concentration from 10 to 30 mg/L; 5-methyl benzotriazole, such as at a concentration of up to 80 mg/L, for example a concentration from 5 to 20 mg/L; pyrazole, such as at a concentration of up to 80 mg/L, for example a concentration of 0.1 mg/L or less; or any combination thereof.

7. The method according to claim 1, wherein the transition metal-azole complex is insoluble in the wastewater and the method further comprises removing at least some of the insoluble transition metal-azole complex to produce an azole-reduce wastewater.

8. The method according to claim 7, wherein removing at least some of the insoluble transition metal-azole complex comprises:
filtering the wastewater to remove at least some of the insoluble complex; or
adding a coagulant, such as ferric sulphate, ferric chloride, or ferrous sulphate, and/or a flocculent, such as a polymeric flocculent, and optionally clarifying the flocculated and/or coagulated wastewater.

9. The method according to claim 7, wherein before removing at least some of the insoluble transition metal-azole complex, the method further comprises adding a sufficient amount of base to the wastewater to result in a pH greater than 4, such as about pH 6.

10. The method according to claim 7, further comprising treating the azole-reduced wastewater in a biological treatment that includes nitrification, optionally without treating the azole-reduced wastewater to oxidation.

11. The method according to claim 1, further comprises treating the wastewater in a biological treatment that includes nitrification, wherein the transition metal-azole complex is insoluble under the biological treatment conditions, optionally without treating the azole-reduced wastewater to oxidation.

12. The method according to claim 11, wherein the biological treatment is at a pH greater than 4.

13. A wastewater treatment system comprising:
a source of wastewater that includes an azole compound;
a reactor in fluid communication with the source of the wastewater; and
a source of a solution comprising transition metal (II) ions in fluid communication with the reactor;
optionally a solids-liquid separator in fluid communication with the reactor.

14. The wastewater treatment system according to claim 13, wherein the solution comprising transition metal (II) ions comprises Cu²⁺ ions, Zn²⁺ ions, Fe²⁺ ions, Cr²⁺ ions, Co²⁺ ions, Mn²⁺ ions, Ni²⁺ ions, or any combination thereof.

15. The wastewater treatment system according to claim 14, wherein the solution comprising transition metal (II) ions is a copper sulfate or copper chloride solution, or comprises a copper ion-containing semiconductor wastewater.

16. The wastewater treatment system according to claim 13, further comprising a source of a pH-modifying solution, such as a base, in fluid communication with the reactor, the source of the pH-modifying solution for maintaining the pH of the wastewater greater than 4.

17. The wastewater treatment system according to claim 13, wherein the solids-liquid separator includes:
a filter, such as a filter having a pore size of 0.1 microns or less, for example a filter having a membrane with an average pore size of about 0.025 μm, or
a source of a flocculent and/or coagulant, and optionally a clarifier.

18. The wastewater treatment system according to claim 13, further comprising a biological treatment unit in fluid communication with a liquid outlet from the reactor or the solids-liquid separator, wherein the biological treatment unit treats the accepted wastewater to nitrification, optionally wherein the wastewater treatment system lacks an oxidation unit upstream of the biological treatment unit.

19. The wastewater treatment system according to claim 13, wherein the source of wastewater is a semiconductor fabrication plant.

20. A method comprising:
adding a solution comprising Cu²⁺ ions to a semiconductor wastewater that includes a triazole compound, such as 1,2,4-triazole; and
allowing the copper ions and the triazole compound in the wastewater to form a copper-triazole complex in the wastewater while maintaining the solution at a pH greater than 4 to produce a treated wastewater;
optionally removing at least some of the insoluble copper-triazole complex to produce a triazole-reduce wastewater;
and optionally discharging the treated wastewater or the triazole-reduce wastewater to a downstream biological treatment that includes nitrification.

21-29. (canceled)
